(19) United States
(12) Patent Application Publication
(10) Pub. No.: US 2020/0276760 A1
(43) Pub. Date: Sep. 3, 2020

(54) PEKK EXTRUSION ADDITIVE MANUFACTURING PROCESSES AND PRODUCTS

(71) Applicant: Arkema Inc., King of Prussia, PA (US)

(72) Inventors: Timothy A. SPAHR, Galesville, WI (US); Bruce CLAY, Boyertown, PA (US); David S. LIU, Bala Cynwyd, PA (US); Julien JOUANNEAU, Bryn Mawr, PA (US)

(21) Appl. No.: 16/646,192

(22) PCT Filed: Sep. 14, 2018
(86) PCT No.: PCT/US2018/050998

§ 371 Date: Mar. 11, 2020

Related U.S. Application Data
(60) Provisional application No. 62/558,942, filed on Sep. 15, 2017.

(51) Int. Cl. B29C 64/30; B29C 64/118; B33Y 10/00; B33Y 40/20; B33Y 70/00

(52) U.S. Cl. CPC B29C 64/30; B29C 64/118; B29K 2271/00; B33Y 40/20; B33Y 70/00; B33Y 10/00

(57) ABSTRACT

The present invention is directed to material extrusion additive manufacturing processes, including fused filament fabrication, used to manufacture improved parts, devices, and prototypes using polyetherketoneketones (“PEKK”) and polyetheretherketones (“PEEK”). Using the improved processes of the invention, PEKK or PEEK polymer readily is 3D printed by FFF such that it crystallizes slowly enough during deposition for the resulting part to remain mostly or substantially amorphous during printing and thus have low percentage and/or more uniform shrinkage per layer and little to no warping from the base during print, and yet fast enough so that the resulting part crystallizes in post-print processing without substantial or any loss of its printed structure.

### FIELD OF THE INVENTION

The invention relates to material extrusion additive manufacturing processes, including fused filament fabrication, which may be used to manufacture improved parts, devices, and prototypes using thermoplastic polymer compositions comprising polyarylketones such as polyetherketoneketones (“PEKK”) and polyetheretherketones (“PEEK”).

### BACKGROUND

Material extrusion additive manufacturing are processes which may be used to manufacture devices, parts, and prototypes. Material extrusion additive manufacturing includes fused filament fabrication (“FFF”) processes and material extrusion processes, which are used interchangeably herein unless otherwise noted.

The use of amorphous thermoplastic polymers in FFF is known. See, for example, Additive Manufacturing Technologies: 3D Printing, Rapid Prototyping, and Direct Digital Manufacturing, Gibson, I., Rosen, D., and Stucker, B; Springer, 26 Nov. 2014, at 164. Such material, however, present disadvantages and challenges. For example, amorphous materials have lower chemical resistance compared to semi-crystalline materials of a similar polymer. Parts made from amorphous thermoplastic polymers possess low continuous usage temperatures (that is, parts have a usage at relatively low specific temperature range, compared to a part made from a semi-crystalline material of a similar polymer). Semi-crystalline thermoplastics such as polyaryletherketones (“PAEK”) are thus interesting for applications that require such high performance parts. PEEK has been investigated for such applications but found deficient.

When used with FFF processes, semi-crystalline PEEK typically provides undesirable warping and shrinkage rendering the resulting objects/products unsuitable for use. A proposed way to address these deficiencies, as described in U.S. Pat. No. 9,527,242 is to use a blend of a semi-crystalline polymer and another polymer material. U.S. Pat. Pub. 2015/0874963 describes such a blend comprising semi-crystalline PAEK and an amorphous polymer. Both processes require a preliminary step of blending these components together, making it an expensive and time consuming fabrication. In addition, the materials crystallize during printing thus resulting in uneven and/or non-uniform shrinking of layers and warping from the build plate as the part crystallizes.

FFF printing processes with PEKK can result in product/device/material that is nearly fully crystallized after printing (as with PEEK). Such printing process with PEKK yield poor Z direction properties at routine melt processing temperatures typically used in conventional melt extrusion processes, as well as significant warping from the build plate which limits the size of the part that can be printed. Known FFF printing processes with PEKK typically having a T:I ratio of 60:40 result in material that is substantially amorphous after printing and yield undesirable lower temperature ranges of use meaning that the resulting part does not maintain dimensional stability at temperatures higher than the polymer's Tg.

### SUMMARY OF THE INVENTION

Therefore there is a need for an improved process in which a PAEK polymer could be readily printed by FFF such that on the one hand, it crystallizes slowly enough during deposition for the resulting part to remain mostly, substantially, or even totally amorphous during printing and thus have a lower percentage and/or more uniform shrinkage per layer and little to no warping from the base/build structure during print, and on the other hand, fast enough so that the resulting part may substantially or fully crystallize in a post-processing step without a loss of its printed structure. The present invention provides such advantages.

Another advantage of the present invention, generally not possible with other polymeric materials, is the ability to control crystallization by manipulation of at least two independent variables; namely (i) the T:I ratio of the copolymer of the thermoplastic polymer composition and (ii) the process and/or device printing parameters. That is, first the rate of crystallization of PEKK or PEEK copolymer can be tuned by adjusting the PEKK or PEEK compositions of the thermoplastic polymer composition. In the case of PEKK, the rate of crystallization can be tuned by adjusting, for example, the T:I ratio of the PEKK. Second, the printed percent crystallinity of the product/device/article may be further fine-tuned by the adjusting printing parameters of the process and/or device. In other words, product properties may be maximized and controlled via a selection of various combinations of adjustments to the PEKK or PEEK copolymer composition and/or the printing parameters. Thus the invention provides PEKK or PEEK having optimized crystallization rates to print substantially amorphous or fully amorphous PEKK or PEEK comprising products/parts/articles having low warping and crystallization rates, and which are subsequently crystallizable using post printing steps such as heat treatment. Using the claimed invention, crystallizations occurs substantially uniformly layer to layer and without significant distortion during printing.

In one embodiment of the invention, desirable properties are achieved by choosing a thermoplastic polymer composition comprising, consisting essentially of, or consisting of PEKK copolymer having a T:I ratio that is between about 61:39 and 85:15, in some embodiments from about 65:35 to 80:20, in particular from about 68:32 to 75:25, and which preferably may be about 70:30.

The inventors further discovered that, contrary to current understanding, extrusion printing in a chamber between about the cold crystallization temperature and Tg of the co-polymer or copolymer blend promotes undesirable crystallization and/or warping. In contrast, the invention provides processes and products such that during printing the weight percent crystallinity remains at 15% or less, preferably at 10% or less, more preferably at 5% or less, as measured by x-ray diffraction.

In yet another embodiment, the invention provides a process whereby during extrusion printing and prior to post printing treatment, the PEKK or PEEK polymer or polymer blend of the printed article remains substantially amorphous or fully amorphous.

Post printing treatment such as by heating then increases the weight percent crystallinity of the PEKK containing part/device/article to about 15% or greater, or about 20% or greater, or about 25% or greater, or about 30% or greater, up to about 35%.

Therefore, the invention provides a novel process for making products and finished articles, parts, devices, products, and/or prototypes having surprisingly higher crystallinity and lower, more uniform warping in the final product/article/part/device/prototype compared to finished products made from blends containing amorphous or semi crystalline polymer. The resulting more crystalline parts/devices/articles can be used for applications that require higher temperatures of use and higher chemical resistance.

The inventors further unexpectedly discovered that certain thermoplastic polymer composition including PEKK or PEEK polymers having a certain configuration can be used as single polymer (i.e., not a blend of two or more different polymers), and result in products with desirable properties. As a result, the methods and compositions of the invention are easier, quicker, and more economical to use.

In addition, the inventors unexpectedly discovered that certain thermoplastic polymer compositions comprising, consisting essentially of, or consisting of PEKK or PEEK polymers under certain specified printing conditions, and before heat treatment to increase crystallinity, can yield a highly dense, low porosity part, with increased optical transmittance, and reduced haze. A printed part can reach a density of 95% or greater, preferably 97% or greater, more preferably 98% or greater, and even more preferably 99% or greater as measured by specific gravity using ASTM method D792.

### BRIEF DESCRIPTION OF THE DRAWINGS

FIG. 1 shows the wide angle x ray diffraction (WAXD) pattern of a 2 mm thick section of PEKK with a 70:30 T:I ratio printed at a chamber temperature of 80° C.

FIG. 2 shows the wide angle x ray diffraction (WAXD) pattern of a 2 mm thick section of PEKK with a 70:30 T:I ratio printed at a chamber temperature of 80° C., after the crystallization procedure described in EXAMPLE 1 wherein the sample was heated at 200° C. for 1 hour or 2 hours.

FIG. 3 illustrates a five (5) inch PEKK part made from PEKK having a 70:30 T:I ratio and made according to the invention. The parts shown are as printed (top) and post print heated (bottom) showing no additional warpage or change of dimensions.

FIG. 4 illustrates a PEEK tensile specimen (comparative) with the poor layer adhesion as evidenced by the gaps between layers.

FIG. 5 illustrates shrinkage observed on an as printed article printed from PEKK having a T:I ratio of 70:30 (top) and an article printed from PEEK (bottom). As observed in FIG. 5, the PEKK specimen exhibited less shrinkage as see from the vertical edges of each specimen. The edges of the PEKK specimen appear substantially straight whereas the edges of the PEEK specimen curve inward indicating uneven shrinkage.

FIG. 6 is a plot of the crystallinity predicted in the finite element analysis model of EXAMPLE 3. This demonstrates that the “as printed” crystallinity of parts made in accordance with the invention is less than 15 weight percent crystallinity.

FIG. 7 is an example of the geometry used and output of the finite element model used in EXAMPLE 3.

### DESCRIPTION OF THE INVENTION

As used herein, an “amorphous” polymer refers to a polymer that does not present any measurable crystallinity by x-ray diffraction (XRD).

As used herein, “HDT” means heat deflection temperature, measured using DSC according to ASTM method D3418 with an applied force of 0.45 MPa.

As used herein, X, Y directions refers to directions parallel to the print plate and Z direction refers to the direction perpendicular to the print plate.

Polyetherketoneketone (“PEKK”) comprises units of the following formulas:

(—Ar—X—) and (—Ar₁—Y—) Formula I

wherein:
Ar and Ar₁ represent each a divalent aromatic radical and are preferably selected among 1,3-phenylene and 1,4-phenylene;
X represents an electron-withdrawing group which is preferably a carbonyl group; and
Y represents an oxygen atom.

The polyether ketone ketone comprises moieties of formula II A and of formula IIB:

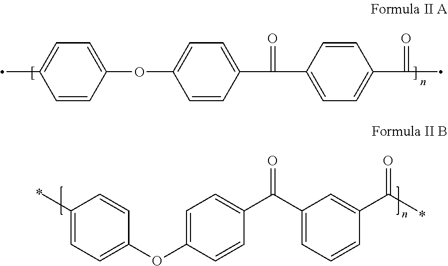

According to a preferred embodiment, the polyetherketoneketone comprises, consists essentially of, or consists of, of moieties of formula IIA and IIB. Among these polymers are especially preferred polyether ketone ketones that have a molar ratio of moieties of formula II A:moieties of formula IIB (also called T:I ratio) that is between about 61:39 and 85:15, and in some embodiments from about 65:35 to 80:20, in particular from about 68:32 to 75:25, and which preferably may be about 70:30.

Suitable polyetherketoneketones are available from under the brand name KEPSTAN® polymers from Arkema Inc., King of Prussia, Pa., including the KEPSTAN® 6000 and 7000 series polymers.

Alternatively, the polyetherketoneketone may comprise other aromatic moieties of the formula I above, notably moieties where Ar and Ar₁ may also be selected from bicyclic aromatic radicals such as 4,4′-diphenylene or divalent fused aromatic radicals such as 1,4-naphtylene, 1,5-naphtylene and 2,6-naphtylene.

In one embodiment of the invention, desirable properties are achieved by choosing a thermoplastic polymer composition comprising, consisting essentially of, or consisting of PEKK copolymer having a T:I ratio that is between about 61:39 and 85:15, in some embodiments from about 65:35 to 80:20, in particular from about 68:32 to 75:25, and which preferably may be about 70:30. Notably, the PEKK utilized in the thermoplastic polymer compositions of the invention is a random copolymer, in contrast to the block copolymer having segments having very different crystallization behavior as described in U.S. Pat. No. 9,527,242.

According to a preferred embodiment, the thermoplastic polymer composition comprises, consists essentially of, or consists of PEKK copolymer having a molecular weight such that its inherent viscosity in 96% sulfuric acid according to ISO 307 test method is between about 0.5 and 1.5 dL/g, preferably between about 0.6 and 1.2 dL/g, more preferably between about 0.7 and 1.1 dL/g.

The preferred compositions of the invention including those comprising, consisting essentially of, or consisting of PEKK, exhibit crystallization half times at 250° C. which are greater or equal to about 2 seconds and less than 1 minute, preferably between about 4 and 30 seconds, even more preferably between about 5 and 20 seconds. Crystallization half time at a given temperature is the time necessary for the material to develop half of its maximum crystallinity content, using x-ray diffraction.

Crystallinity of the polymer may be measured, e.g., by X-ray diffraction (XRD). Crystallinity of the polymer may also be measured, e.g., by differential scanning calorimetry (DSC). For instance, X-ray diffraction data may be collected with copper K-alpha radiation at 0.5 deg/min for two-theta angles ranging from 5.0° to 60.0°. The step size used for data collection should be 0.05° or lower. The diffractometer optics should be set as to reduce air scattering in the low angle region around 5.0° two-theta. Crystallinity data may be calculated by peak fitting X-ray patterns and taking into account crystallographic data for the polymer of interest. A linear baseline may be applied to the data between 5° and 60°.

In some embodiments of the invention, the thermoplastic polymer compositions further comprise fillers and/or additives, such as one or more of carbon fibers, glass fibers, carbon nanofibers, basalt fibers, talc, carbon nanotubes, carbon powders, graphite, graphene, titanium dioxide, pigments, clays, silica, processing aids, antioxidants, stabilizers, and the like. The thermoplastic polymer compositions may further comprise additives that can adjust or modify the thermal properties of PEKK, or any additive that can change polymer or polymer blend Tg, Tm (melt temperature), Tc (crystallization temperature), crystallization kinetics (speeding up or slowing down), melt viscosity, and chain mobility.

Material Extrusion Additive Process

For the material extrusion additive 3D printing processes of the invention, the thermoplastic polymer composition, polymer, copolymer, or filled polymer formulations used may be in the form of filaments or pellets, generally formed by extrusion, or may be in the form of powder or flakes.

Notably, the 3-D printing of this invention is not a laser sintering process. Instead, the compositions or resins may be “3D” printed in an extrusion (for example, fused filament fabrication) style 3D printer, with or without filaments. For fused filament fabrication, the filaments may be of any size diameter, including from about 0.6 to 3 mm, preferably about 1.7 to 2.9 mm, more preferably diameters of about 1.7 mm and about 2.8 mm, even more preferably 1.75 mm, 2.85 mm or other sizes, measured with an unweighted caliper. The filaments may be extruded with any sized nozzle device that can extrude filament, pellets, powder or other forms of the thermoplastic polymer composition comprising PEKK or PEEK copolymer.

A device useful for material extrusion additive manufacturing generally comprises all or some of the following components:
(1) consumable material in the ready to print form (filament, pellets, powder, flakes, or polymer solution as specified by the printer);
(2) a device feeding the material to the print head;
(3) one or more print heads with a nozzle that can be heated up or cooled to a specified temperature for extruding of the melted material;
(4) a print bed or substrate which may or may not be heated, where the part is being built/printed; and
(5) a build chamber surrounding the print bed and the object being printed which may or may not be heated or which may or may not be temperature controlled.

Generally, the extrusion printing process comprises one or more of the following steps:
(1) feeding the thermoplastic polymer composition comprising PEKK or PEEK copolymer filament, pellets, powder, flakes, or polymer solution into a 3D printer, the parts of which may or may not be heated to one or more predetermined temperatures;
(2) setting the computer controls of the printer to provide a set volume flow of material, and to space the printed lines at a certain spacing;
(3) feeding the thermoplastic polymer composition comprising PEKK or PEEK polymer composition to a heated nozzle at an appropriate set speed which may be pre-determined; and
(4) moving the nozzle into the proper position for depositing a set or predetermined amount of thermoplastic polymer composition comprising PEKK or PEEK polymer material; and
(5) optionally adjusting the temperature of the build chamber.

In one embodiment, the feed into the printer has a low shear melt viscosity between about 100 and 2000 Pa·s at 1 Hz at the printing temperature. The printer may be operated at room temperature, i.e. with no heated bed and/or heated build chamber. Alternatively, the bed and/or build chamber may be temperature controlled, and for example have a heated bed of about 50-200° C., preferably above about 90° C., more preferably above 120° C., even more preferably above 140° C. The heated bed may also be at about 160° C., or just under the Tg of the polymer or polymer blend.

In another preferred embodiment, the 3-D printer may be programmed to operate at 105 to 130% overflow. This means that the volume of thermoplastic polymer composition fed by the printer is higher than the calculated volume required for the 3-D article being formed. Overflow may be controlled to result in a denser and mechanically stronger part. Overflow also helps to compensate for shrinkage, while increasing the strength and mechanical properties of the printed article. The overflow can be set by at least two different methods. In the first method, the software/printer is set to feed a higher percent of material into the nozzle than would be normally needed. In the second method, the software/printer may be set to decrease the spacing between lines, and thus create an overlap in the lines, resulting in extra material being used to print the article.

Process parameters of the 3-D printer can be adjusted to minimize shrinkage and warping, and to produce 3-D printed parts having optimum strength and elongation. The use of selected process parameters applies to any extrusion/melt 3D printer, and preferably to filament printing (e.g. FFF).

The nozzle temperature is maintained at a temperature between about 335° C. to 425° C., preferably between about 350° C. to 400° C.

The print (head) speed may be between 0.5 to 8.0 in/sec (13 to 200 mm/sec).

In one embodiment the print speed, layer thickness, nozzle temperature, and chamber temperature is adjusted so that the part that is printed and before any further crystallization step takes place (such as for example by heating) is only partially crystallized, having a weight percent crystallinity of 15% or less, preferably at 10% or less, and more preferably at 5% or less. In another embodiment, the print speed, layer thickness, nozzle temperature, and chamber temperature is adjusted so that the part that is printed and before any further crystallization step takes place (such as for example by heating) is substantially amorphous or amorphous, and yet is crystallizable post printing.

Surprisingly, the inventor's discovered that printing with a build chamber temperature maintained at less than the polymer's or polymer blend's cold crystallization temperature (as measured by DSC), preferably at least 50° C. below the cold crystallization temperature, more preferably at least 80° C. below the cold crystallization temperature, to prevent the printed part from more fully or fully crystallizing during print.

In another embodiment, the build chamber during printing may be operated at temperatures between about 18° C. (room temperature) to a temperature maintained at less than the polymer or polymer blend Tg (as measured by DSC), or between 40° C. (absolute) and 20° C. below Tg, or between 60° C. (absolute) and 40° C. below Tg.

In yet another embodiment, the build chamber (or print area) may be operated at temperatures between about 18° C. to 280° C., or between about 35° C. to 220° C., or between about 60° C. to 160° C., or between about 70° C. to 130° C.

In yet another embodiment, the build chamber (or print area) is operated and maintained at a temperature less than 160° C., preferably less than °140, more preferably less than 120° C.

In yet another embodiment, the build chamber (or print area) is operated and maintained at a temperature from about 60° C. and to about 120° C., preferably from about 60° C. and to about 100° C.

An advantage of the present invention is the ability to print less warping, stronger parts/devices/articles with better dimensional stability (after post print treatment using for example annealing), while printing at lower build chamber temperatures (for example, less than 160° C.) compared to other PAEK materials. Moreover, the lower build chamber temperature does not require sophisticated design, materials, and heat management systems, lowering overall printer cost.

In addition, the process may take place in air, or under an inert gas such as nitrogen. The printing process may occur at atmospheric pressure or under vacuum.

The thickness of each print layer may be about 0.004 inches (0.10 mm) to 0.1 inches (4 mm).

Description of Exemplary Post Printing Processing

Another advantage of the invention, typically not achieved with other materials and processes, is adjustment of polymer crystallization rates by way, for example, of T:I ratio of PEKK such that the printed percent crystallinity may be further modified during post printing processing/crystallization steps.

The process of the invention further includes the step of heat treating the article produced by the extrusion printing step to provide a post printed article having increased crystallinity (weight percent), compared to the weight percent crystallinity of the article produced by the extrusion printing step and pre-heat treatment.

After printing, the resulting 3-D articles may be placed in an oven (with or without oven time temperature programmability) at a temperature time period to be specified or which is predetermined to increase the part's/article's percent crystallinity, mechanical properties, and its temperature of use, while preserving the strength of the polymer's interlaminate adhesion (also called “the Z direction strength”). This crystallization step may be done at a temperature above the polymer's Tg (for example, for PEKK, 160° C.-165° C.). It also can be done on parts with an initial 2% to 98% of the polymer's possible crystallinity. Optionally, the post treatment process could occur by increasing the build chamber temperature after the printing process has been completed without removing the part from the build chamber.

The post printing crystallization temperature may be between a temperature of about 160° C. to 320° C., or between about 180° C. to 290° C., or between about 220° C. to 290° C., or between 200° C. to 250° C. The time period for the post printing crystallization process is/are single or multiple temperature steps having a duration between about 1 minute and 24 hours, preferably between about 3 minutes and 3 hours, more preferably between about 10 minutes and 60 minutes per temperature step. Post printing crystallization may also comprise the step of heating past the point the part reaches maximum crystallinity, up to, for example, 24 hours.

Preferably, post printing crystallization is a multistep temperature step process. In one embodiment of the multistep temperature process, the first step is at about 150-170° C., or at about 160-165° C., for about 30 minutes to 3 hours, or from about 1 to 2.5 hours, or for about 1 hour; the second step being at about 180-240° C., or from about 200-230° C. for about 30 minutes to 3 hours, or from about 1 to 2.5 hours, or for about 1 hour. Using the processes of the invention, a post printed article with a final weight percent crystallinity of greater than 15%, preferably 20% or greater, more preferably about 25% or greater, most preferably at least 30% or greater, up to about 35%, was produced. Depending on part size and geometry, the time for both the first and second steps can be optimally scaled to accommodate larger parts.

In one embodiment post printing crystallization comprises heating and equilibrating the printed part to a temperature within about 10° C. of the Tg of the polymer or polymer blend and then slowly heating to the crystallization temperature. This slow, multi stage heating cycle reduces distortion during crystallization that might otherwise occur if the printed part was heated quickly and unevenly.

Upon printing and before any post printing heating steps, the part/article of the invention which is a semi-crystalline article comprising PEKK copolymer will have an elongation and yield strength when printed and tested in the XY direction that is similar to that of an injection molded article of the same composition, maintaining over about 40%, 50%, 60%, 70%, 80%, 90% or more, and in some cases over about 95% of the stress at yield of the part/article of the same composition made by injection molding. Likewise, post printing and after further heat treatment to increase crystallization, the part/article of the invention which is a semi-crystalline article comprising PEKK copolymer will have an elongation and yield strength when printed and tested in the XY direction that is similar to that of an injection molded article of the same composition, maintaining over about 50%, over about 75%, preferably over about 85%, and in some cases over about 95% of the stress at yield of the part/article of the same composition made by injection mold. In addition, the Z direction stress at yield will average greater than about 20%, preferably greater than about 30%, more preferably greater than about 40%, 50%, 60%, 70%, 80%, 90% or more, of the stress at yield in the XY direction of the part without filler.

In one embodiment, the article produced using PEKK has a Z-direction tensile stress at yield or break greater than about 40% of the x-y direction tensile stress at yield or break.

By contrast, articles comprising PEEK polymer (used per se, without additives) printed in the extrusion printing process yields a Z direction stress at yield averaging less than 10% of the stress at yield in the XY direction of the part without the addition of fillers at similar print conditions.

In one embodiment, the present invention provides a material comprising a single PAEK composition, such as PEKK, yielding parts with a HDT above about 200° C., preferably about 250-260° C., and a Z direction tensile stress at yield or break greater than 40% of the x-y direction tensile stress at yield or break. PEKK copolymer having a 60:40 T:I ratio material has a HDT of less than 160° C. The inclusion of fibers or other reinforcements may further increase the HDT of a finished article.

Thus, for each thermoplastic polymer composition of the invention comprising PEKK or PEEK polymer, depending on its crystallization rate and T:I ratio (to the extent there is one), there is a build chamber temperature in which temperature is determined and optimized such that the part/article/device surprisingly prints substantially or mostly amorphous. For example, for PEKK having a T:I ratio of 70:30, that temperature is about 90° C. Any hotter, and the part starts becoming unacceptably crystalline during printing. This finding is counter to previous understandings that the favored higher build chamber temperatures.

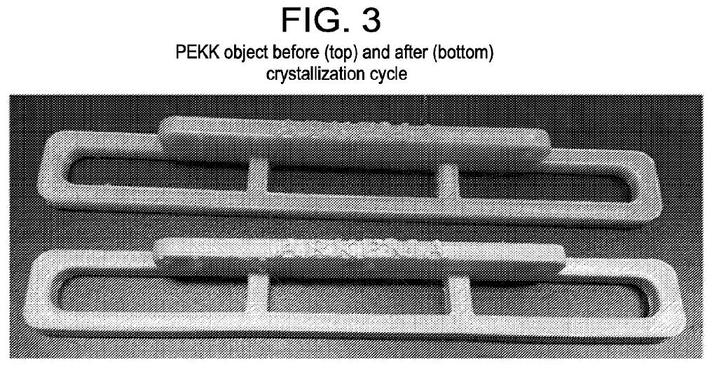

FIG. 3 shows a 5 inch substantially flat part made in accordance with the invention which is larger and flatter than typically obtained using PEEK polymer which suffers from shrinkage.

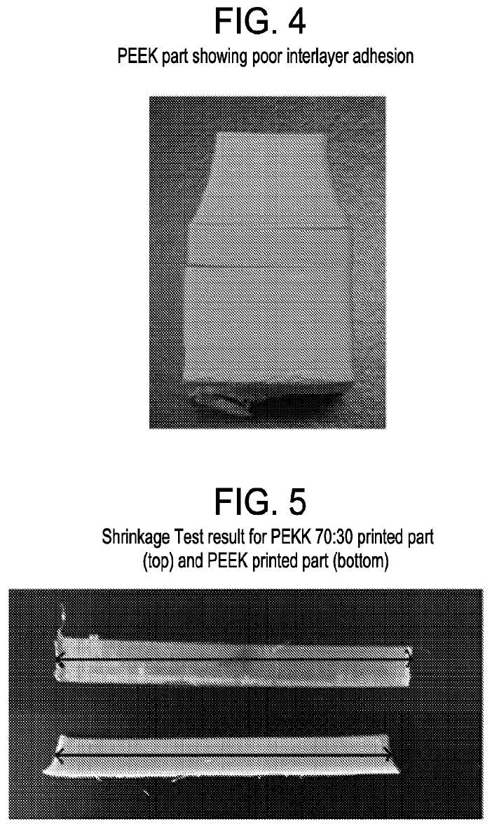

FIG. 4 illustrates a PEEK tensile specimen (comparative) with poor layer adhesion as evidenced by the gaps between layers and resulting distorted profile configurations.

FIG. 5 illustrates shrinkage observed on an “as printed article” printed from PEKK having a T:I ratio of 70:30 (top) and another article printed from PEEK (bottom). As observed in FIG. 5, the PEKK specimen exhibited less shrinkage as see from the vertical edges of each specimen. The edges of the PEKK specimen appear substantially straight whereas the edges of the PEEK specimen curve inward indicating uneven shrinkage and undesirable warp-age.

The processes of the invention can also provide “near net shapes” by, for example, printing a slightly oversized part, crystallizing it, and then machine or cutting the part to the desired shape, including for example drilling of holes.

### EXAMPLES

### Example 1

Filament 1.75 mm in diameter was prepared by extrusion with samples PEKK (1) and PEKK (2), having T:I ratios of 60:40 and 70:30 respectively. PEEK filament 1.75 mm in diameter was purchased from Essentium Inc. Filament prepared with PEKK (1) and PEKK (2) was transparent, indicating that the polymer was substantially amorphous. The PEEK filament was opaque, suggesting at least some degree of crystallinity. Modified ASTM D638 Type IV tensile bars were created in a FFF process in both a horizontal and vertical orientation. For all materials, a 0.4 mm diameter nozzle and 0.2 mm layer height was used. PEKK (1) was printed using an extruder temperature of 360° C., PEKK (2) at 375° C. and PEEK at 420° C. PEEK was printed at a higher temperature than PEEK (2) despite its lower melting point because at lower temperatures layer adhesion was too poor to complete a print. A chamber temperature of 75° C., and heated bed of 160° C. was used for all prints. The specimens printed in the horizontal direction have the raster orientation oriented in alternating directions 45° from the testing direction. The vertical orientation direction samples directly measure the layer adhesion. Half of the PEKK tensile specimens were crystallized by heating in an oven to 160° C. for one hour, followed by 200° C. for one hour. The tensile strength was measured according to ASTM D638 standards, and the crystallinity was measured by WAXD.

Results are report in Table 1 Specimens printed with PEKK (1) filament showed little or no increase in crystallinity during this crystallization cycle, and samples prepared in the vertical orientation distorted during the crystallization cycle and could not be tested. Tests with PEKK (2) show that with the appropriate T:I ratio and printing conditions, it is possible to produce a mostly amorphous part that can be crystallized in a secondary process to increase its strength. Parts printed with PEKK (2) at high build chamber temperatures had significant distortions and poor layer adhesion. During the crystallization process, parts shrink uniformly and predictably 2.5% in the x and y axis and about 0.5% in the z axis.

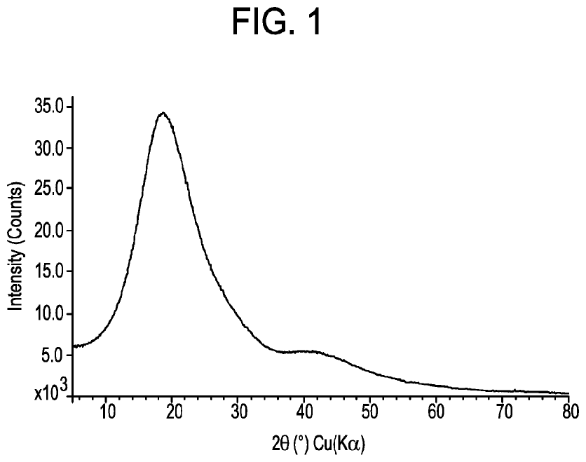

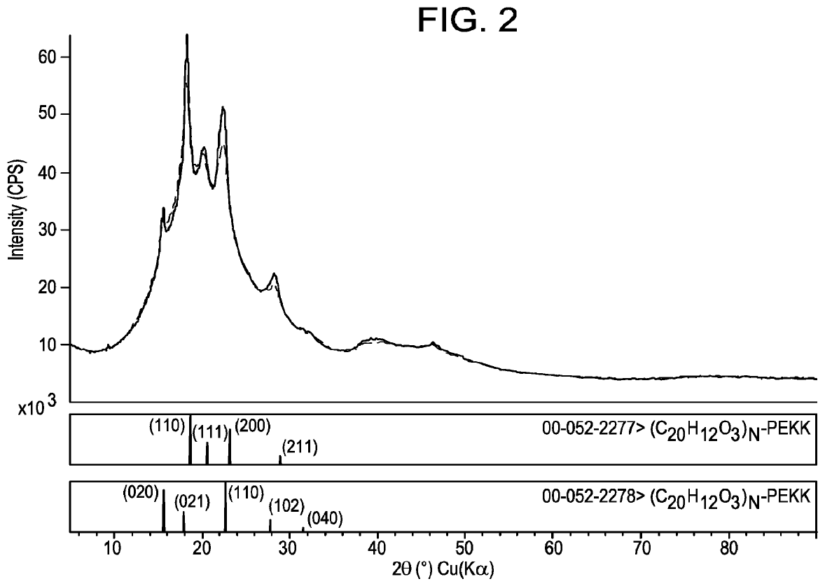

FIGS. 1 and 2 depicts the data set forth in Table 1 for PEKK (2) as printed and PEKK(2) post treatment.

TABLE 1

| | | Crystallinity | | | | |
|---|---|---|---|---|---|---|
| | | (wt. % via | XY maximum | XY elongation | Z maximum | Z elongation |
| | | WAXD) | stress (MPa) | to break (%) | stress (MPa) | to break (%) |
| PEKK | as printed | 0% | 83 | 10.4% | 48 | 5.5% |
| (1) | | | | | | |
| PEKK | post | 0% | 87 | 11.0% | n/t | n/t |
| (1) | treatment | | | | | |
| PEKK | as printed | 0-2.5% | 84 | 13.0% | 51 | 4.8% |
| (2) | | | | | | |
| PEKK | post | 22% | 90 | 8.2% | 56 | 5.2% |
| (2) | treatment | | | | | |
| PEEK | as printed | 21% | 79 | 19.9% | 5 | 5.0% |

### Example 2

To measure distortions while printing, a long narrow item was printed about the width of two extrusion passes (0.8 mm), about 1 cm tall, and 4 cm long with the printing and crystallization conditions used in Example 1. The percent difference in dimension on the long axis of the printed part (taken in the shortest section) compared to the specified, theoretical length (4 cm) was measured as a way to quantify layer distortion/shrinkage during printing. Table 2 list the percent shrinkage measured for PEEK (2) as printed, PEKK (2) crystallized, PEEK as printed, and an acrylonitrile butadiene styrene amorphous polymer (“ABS”). The results show that PEKK has shrinkage similar to a typical ABS and substantially less than PEEK while printing. Upon crystallizing through the post-process step, the PEKK (2) part experiences further, but uniform shrinkage.

TABLE 2
Shrinkage Data

| Material | % Distortion on Thin Wall |
|---|---|
| PEKK (2) as printed | 1.2% |
| PEKK (2) after post-processing | 3.0%* uniform shrinkage |
| PEEK as printed | 4.4% |
| ABS | 1.1% |

*Uniform shrinkage

### Example 3 (Modeling Example)

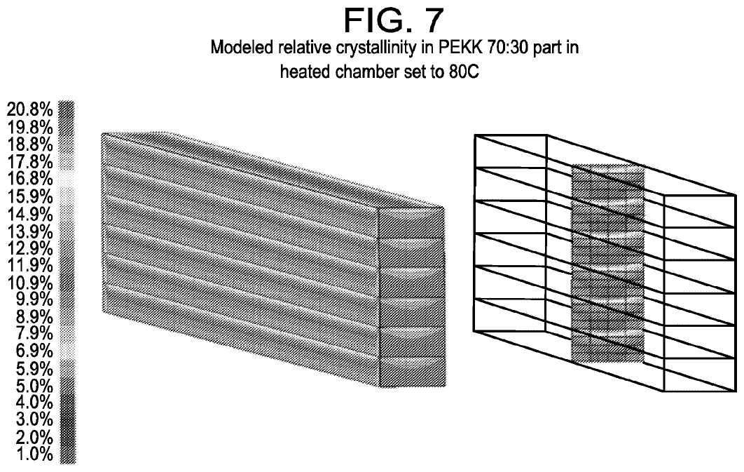

A finite element model tracking temperature and crystallinity was constructed to predict the internal and external crystallinity of a simple 3D printed PEKK 70:30 part consisting of 10 vertically stacked layers that are each 160 mm long, 0.4 mm wide, and 0.2 mm thick. The geometry used by the finite element model of this example is shown in FIG. 7. The model included the following material and process parameters:
1) Temperature of the polymer as it exits the nozzle.
2) Temperature of the heated chamber between 40 C and 240 C.
3) Temperature of a stage supplying heat to the printed part set to 150 C.
4) Physical properties of PEKK with a T:I ratio of 70:30, including density, thermal conductivity, and heat capacity.
5) Print speeds up to 50 mm/s, in particular 10 mm/s and 50 mm/s.
6) Cross sectional area of printed layers defined with 0.4 mm width and 0.2 mm thickness.
7) A parameter to account for the effect of reduced contact between layers, trapped air, or reduced interpenetration of polymer chains on heat flow.
8) Parameters to account for the effective heat loss through all interfaces via conductive, convective, and radiative transfer.

Crystallinity within the 3D printed part was derived from the time-temperature-transformation (TTT) diagram of PEKK 70:30 referenced in [Choupin, “Mechanical performances of PEKK thermoplastic composites linked to their processing parameters” (2017)], itself derived from differential scanning calorimetry (DSC) data. The TTT diagram describes the build-up of crystallinity based on time in minutes spent at a fixed annealing temperature. The spatially dependent temperature data predicted by the finite element model was used to predict the incremental rate of crystallization.

FIG. 7 illustrates modeled relative crystallinity of layers 3 to 8 of a 10-layer 3D print with a heated chamber set and maintained at 80° C. The example output of the finite element model (FIG. 7) shows good agreement with XRD data. While XRD measures approximately 0-5% crystallinity, the model predicts a maximum weight % crystallinity of 7% and an average weight % crystallinity of 3%.

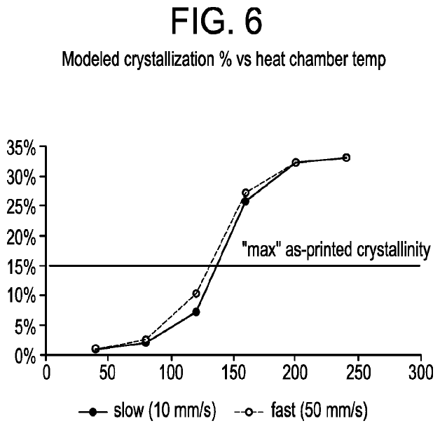

The average crystallinity of parts printed between 40-240° C. as shown in FIG. 6 demonstrate the sensitivity of crystallinity to the heated chamber temperature. In particular the model highlights an inflection point at 120° C. where prints 40° C. above this point (160° C.) show a relative crystallinity of 80% (27% weight crystallinity) and prints 40° C. below this point (80° C.) show a relative crystallinity of 8% (3% weight crystallinity). The model suggests that parts printed 40° C. below the glass transition temperature (120° C.) and preferably 80° C. below the glass transition temperature (80° C.) should remain amorphous and below the cutoff of 5-10% weight crystallinity to minimize warping and shrinkage.

FIG. 6 also illustrates the importance of maintaining low crystallinity to prevent warping, as crystals are predicted to form heterogeneously, with a majority forming near the interface between printed layers.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspect of the invention described herein.

Numerous variations, changes and substitutions will occur to those skilled in the art without departing from the spirit of the invention. Accordingly, it is intended that the appended claims cover all such variations as fall within the spirit and scope of the invention.

1. A material additive manufacturing process for forming a semi-crystalline article using a extrusion printing process comprising at least the following step:
(i) extrusion printing a thermoplastic polymer composition comprising random PEKK copolymer and optionally one or more additives, said PEKK copolymer having a T:I ratio of between about 61:39 to 85:15, to produce an article with a weight percent crystallinity of 15% or less.

2. The material additive manufacturing process of claim 1 further comprising the step of heat treating said article from step 1 to produce a post printed article, whereby the post printed article's weight percent crystallinity is increased.

3. The material additive manufacturing process of claim 1 further comprising the step of heat treating said article from step 1 to produce a post printed article with a final weight percent crystallinity of greater than 15%.

4. The material additive manufacturing process for forming an article using the extrusion printing process of claim 1 wherein the random PEKK copolymer has an inherent viscosity in 96% sulfuric acid between about 0.5 and 1.5 dL/g.

5. The material additive manufacturing process for forming an article using the extrusion printing process of claim 1 wherein prior to post printing treatment, crystallinity of the article is maintained at about 5 weight % or less.

6. The material additive manufacturing process for forming an article using the extrusion printing process of claim 1 wherein, prior to post printing treatment said article is substantially amorphous or amorphous, and is crystallizable post printing.

7. The material additive manufacturing process for forming an article using the extrusion printing process of claim 1 wherein said PEKK copolymer has a crystallization half-time at 250° C. greater than or equal to about two (2) seconds and less than 1 minute.

8. The material additive manufacturing process for forming an article using the extrusion printing process of claim 1 wherein the printer chamber is maintained at a temperature less than the Tg of PEKK copolymer.

9. The material additive manufacturing process for forming an article using the extrusion printing process of claim 1 wherein the printer chamber is maintained at a temperature less than the PEKK copolymer's cold crystallization temperature as measured by DSC.

10. The material additive manufacturing process for forming an article using the extrusion printing process of claim 1 wherein the printer chamber is maintained at a temperature less than 160° C.

11. The material additive manufacturing process for forming an article using the extrusion printing process of claim 1 wherein the printer chamber is maintained at a temperature from about 60° C. and to about 120° C.

12. The material additive manufacturing process for forming an article using the extrusion printing process of claim 1 to produce an article with a Z direction tensile stress at yield or break greater than about 40% of the x-y direction tensile stress at yield or break.

13. The material additive manufacturing process for forming an article using a material extrusion printing process of claim 2 wherein said additional step of heating comprises a multistep temperature process.

14. The material additive manufacturing process for forming an article using the extrusion printing process of claim 1 wherein the thermoplastic composition further comprises fillers and/or additives selected from the group consisting of carbon fibers, glass fibers, carbon nanofibers, basalt fibers, talc, carbon nanotubes, carbon powders, graphite, graphene, titanium dioxide, pigments, clays, silica, processing aids, antioxidants, and stabilizers.
